(19) United States
(12) Patent Application Publication
(10) Pub. No.: US 2020/0205238 A1
(43) Pub. Date: Jun. 25, 2020

(54) DEFROSTING SYSTEM FOR POLYMERIC WINDOW SYSTEMS AND THE LIKE

(71) Applicant: FLEX-N-GATE ADVANCED PRODUCT DEVELOPMENT LLC., Warren, MI (US)

(72) Inventors: Geoffrey Brooks, Macomb, MI (US); Jack Bekou, Windsor (CA)

(21) Appl. No.: 16/723,856

(22) Filed: Dec. 20, 2019

Related U.S. Application Data
(60) Provisional application No. 62/783,864, filed on Dec. 21, 2018.
(60) Provisional application No. 62/813,854, filed on Mar. 5, 2019.

(51) Int. Cl. H05B 3/84; B29C 45/72; B29C 45/14; B29C 45/00; B29K 69/00; B29C 45/16; B29K 33/00

(52) U.S. Cl. CPC H05B 3/84; B29C 45/72; B29C 45/14008; B29C 45/14819; B29C 45/0053; B29K 2069/00; H05B 2203/013; B29C 2045/14704; B29K 2033/12; B29C 2045/14868; B29C 2045/0079; B29C 2045/169; B29C 2045/1693

(57) ABSTRACT

A defrosting system for a window, headlight, or taillight for a vehicle includes a polymeric substrate, an ink layer disposed on the substrate and comprising a conductive or resistive ink, and a film layer disposed on the ink layer such that the ink layer is between the film layer and the polymeric substrate layer.

### CROSS-REFERENCE TO RELATED APPLICATIONS

The present application claims the benefit of priority under 35 U.S.C. § 119(e) to U.S. Provisional Application No. 62/813,854 filed Mar. 5, 2019 and U.S. Provisional Application No. 62/783,864 filed Dec. 21, 2018, the entire contents of which are incorporated herein by reference.

### BACKGROUND

The present application relates generally to the field of defrosting systems for use with polymeric vehicle windows, headlights, taillights, and similar structures.

Current vehicle defrosting systems (e.g., window defrosting systems) are typically designed for use with glass substrates (e.g., rear windows in automobiles). These defrosting systems are epoxy-based and require high temperature processing methods to thermally cure the epoxy. Such high temperature processing methods, however, may not be suitable for windows or structures made from polymeric materials such as polycarbonate materials, which have the advantage of reduced weight as compared to glass windows or panels.

It would be advantageous to provide an improved defrosting system that can be used with polycarbonate-based windows and panels.

### SUMMARY

At least one aspect of the present disclosure is directed to a defrosting system for a window, headlight, or taillight for a vehicle. The defrosting system includes a polymeric substrate, an ink layer disposed on the substrate and comprising a conductive or resistive ink, and a film layer disposed on the ink layer such that the ink layer is between the film layer and the polymeric substrate layer.

At least one aspect of the present disclosure is directed to a method for forming a defrosting system for a window, headlight, or taillight for a vehicle. The method includes die-cutting a film layer, printing an ink layer onto the film layer, and applying a bus bar and at least one electrical connector on the film layer. The bus bar and at least one electrical connector in contact with at least a portion of the ink layer. The method further includes inserting the film layer into a mold and injecting molding a polymeric substrate onto the film layer to encapsulate the ink layer between the film layer and the polymeric substrate. A first side of the film layer contacts a first side of the ink layer, a first side of the polymeric substrate contacts the first side of the film layer, and the first side of the polymeric substrate contacts a second side of the ink layer.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a plan view of a plastic component in accordance with an embodiment of the present disclosure.

FIG. 2 is a schematic cross-sectional view of a portion of a plastic component such as that shown in FIG. 1.

FIG. 3 is a schematic exploded section view of the plastic component shown in FIG. 2.

FIG. 4 is a top plan view of an implementation of a defrosting system for a rear vehicle window.

FIG. 5 is a flow chart illustrating an implementation of a method for forming a defrosting system for a plastic component.

### DETAILED DESCRIPTION

The systems discussed herein provide for a defrosting system for polymeric vehicle windows and structures. The defrosting system may utilize a grid that is located such that it places the heat source close to the surface to be defrosted, thereby providing a high efficiency defrosting system. The requisite amount of heat, and therefore current, can be reduced as compared to systems where a defroster grid is placed further from the surface to be defrosted. According to one particular embodiment, the defroster grid can be composed of a conductive ink that can be dried.

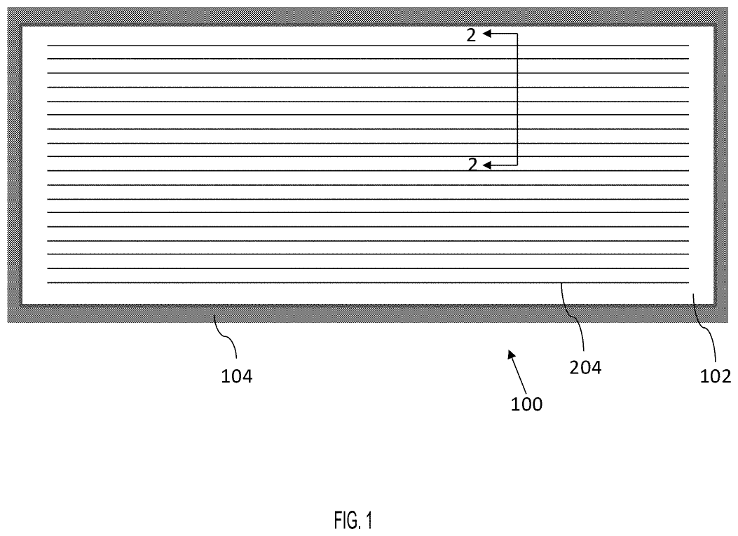

FIG. 1 is a plan view of a plastic component 100 (e.g., a window, headlight, taillight, or other polymeric structure for which it would be desirable to utilize a defrosting system) in accordance with an embodiment of the present disclosure. The plastic component 100 can be made of a plastic material and can include one or more coatings or layers intended to provide resistance to deterioration or damage. Such coatings may provide, for example, one or more of weather resistance, heat resistance, UV protection, humidity resistance, or waterproofing.

The plastic component 100 may be entirely transparent or may include both transparent and non-transparent areas. For example, as shown in FIG. 1, the plastic component 100 includes a transparent area 102 that is configured to allow visibility through the plastic component 100 as well as a non-transparent area 104 (e.g., an opaque area) that is configured to block visibility through the plastic component 100. The non-transparent area 104 can be located along a perimeter of the plastic component 100. The plastic component 100 can be substantially flat or it can be formed into various shapes, sizes, and textures. The size, shape, and configuration of the transparent and non-transparent areas may also differ according to various exemplary embodiments.

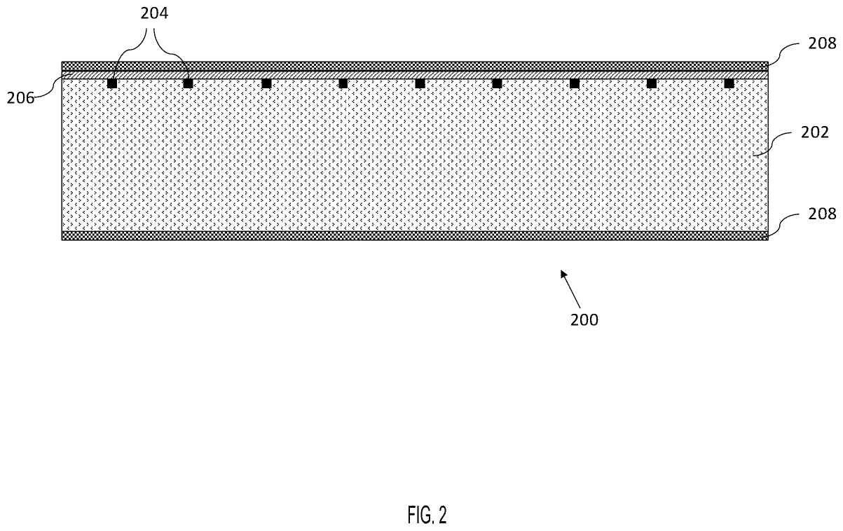

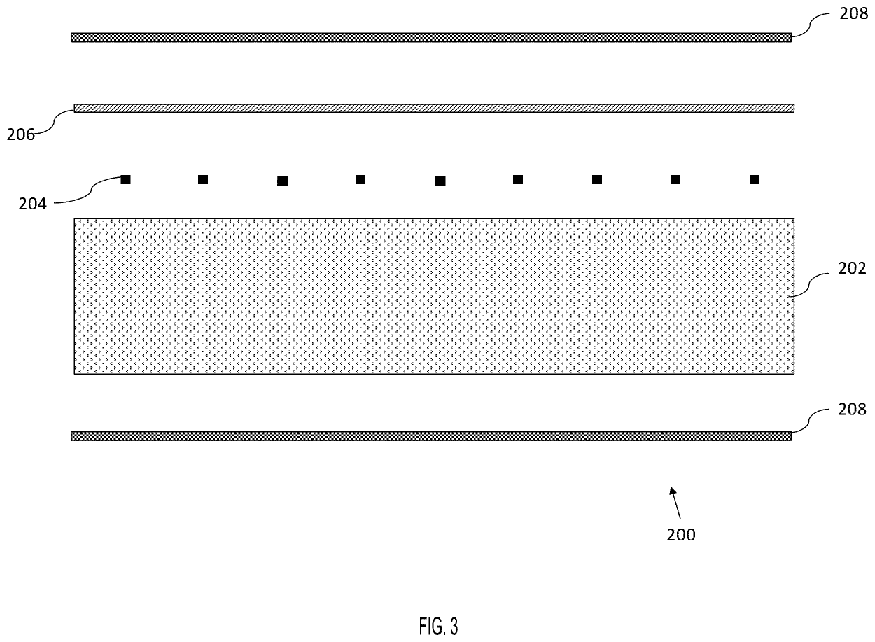

FIG. 2 is a schematic cross-sectional view of a portion 200 of the transparent area 102 shown in FIG. 1 (taken across line 2-2), and FIG. 3 is an exploded view thereof. The portion 200 is a multi-layer structure.

According to an exemplary embodiment, the portion 200 includes a substrate 202 formed of a polymeric material such as polycarbonate material. The substrate 202 can serve as a base providing structural performance of the portion 200. The thickness of the substrate 202 may vary according to various exemplary embodiments.

A layer of ink 204 is disposed on the film layer 206 and can be over-molded with the substrate 202. According to an exemplary embodiment, the ink 204 is a conductive or resistive ink. For example, the ink 204 may be a conductive ink that incorporates a conductive material such as silver, copper, a conductive polymer, or the like.

The ink 204 is intended to act as a functional layer within the portion 200. For example, the ink 204 can operate as a defroster, defogger, light sensor, rain sensor, snow sensor, antenna, or touch sensor. The ink 204 can provide a heat dispersing element within the portion 200 to defrost or defog the portion 200. The ink 204 can be embedded into the film layer 206, it can lie adjacent to the substrate 202, or it can be over-molded with plastic and encapsulated by the substrate 202 and the plastic. Over-molding can protect the ink 204 from damage caused by abrasion and weathering from the exterior.

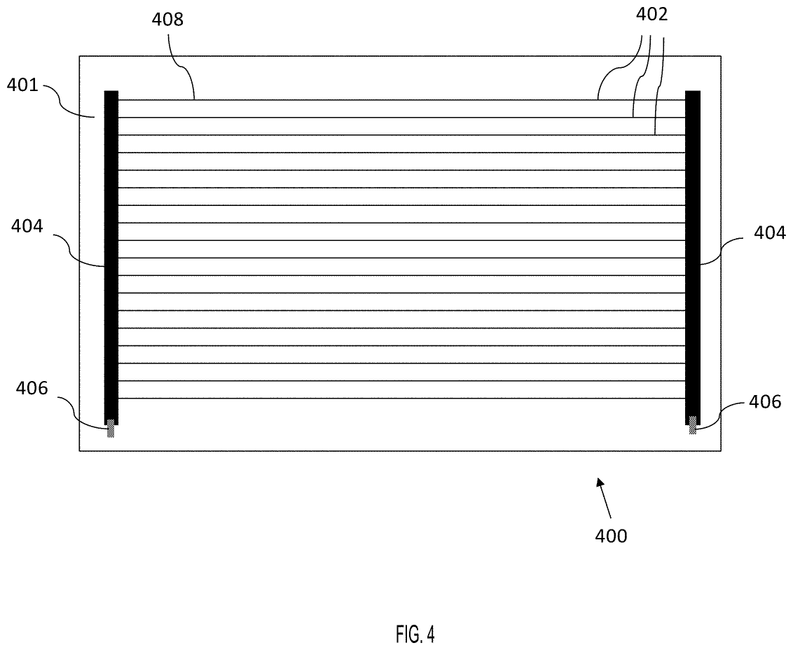

The ink 204 can be formed into a pattern that allows the portion 200 to retain transparency while also providing a functional component. For example, the ink 204 may be patterned to have a grid structure similar to that used in conventional rear window defrosting systems (see, e.g., FIG. 4). Other patterns may also be used according to other exemplary embodiments. The ink 204 is screen printed onto the film layer 206 or may be provided using other suitable processes.

After deposition, the ink 204 can be dried with forced air or infrared systems. The ink 204 can be thermally cured or UV cured. The ink 204 can be suitable for thermoforming processes. According to one exemplary embodiment, the ink 204 can be an air-dry ink that does not need to undergo an extensive heat treatment to bake and cure.

Example properties of the conductive ink are low operating temperature, fast drying, abrasion resistance and hardness, creasability, fine line printability, extended screen residence time, low sheet resistance, superior adhesion to polyester film, and screen printability.

The portion 200 can include a film layer 206 adjacent to the ink 204. The film layer 206 can be comprised of polymethylmethacrylate (PMMA) and can be disposed over the ink 204. The film layer 206 can have a thickness which is approximately in the range of 0.1 mm to 3.0 mm, although the thickness may differ in other embodiments. For example, the film layer 206 can have a thickness of 0.25 mm. According to one exemplary embodiment, the film layer 206 can act to resist degradation due to weathering and can include UV absorbing material. Examples of UV absorbing material are encapsulated benzophenone-3 (TB-MS), avobenzone (TA-MS), octyl methoxycinnamate (TO-MS), and diethylamino hydroxybenzoyl hexyl benzoate (TD-MS). The film layer 206 can serve as a filtering agent and provides weathering performance while the substrate 202 serves as a base providing structural performance of the portion 200. The film layer 206 formed of a polymeric material such as a polycarbonate material. According to a particular exemplary embodiment, the film layer 206 is a thin film comprising coextruded polycarbonate and polymethylmethacrylate (PMMA) layers. The film 206 can have a thickness which is approximately in the range of 0.1 mm to 1.0 mm, although such thickness may differ according to other exemplary embodiments. Overall thickness of the construction can be in the range of 2.0 mm to 6.0 mm.

A scratch-resistant coating 208 may be provided over the film layer 206 according to an exemplary embodiment. The scratch-resistant coating 208 can be applied to the substrate 202 and the film layer 206. The scratch-resistant coating 208 can be a hard coat to provide abrasion resistance. The scratch-resistant coating 208 can protect the portion 200 from impacts and abrasion sustained from an environment exterior to the portion 200. The scratch-resistant coating 208 can be applied using any vacuum deposition technic such as magnetron sputtering, electron beam evaporation, plasma enhanced chemical vapor deposition (PECVD) or expanding thermal PECVD. The scratch-resistant coating 208 can be exposed to a variety of different exterior environments. Examples of exterior environments can include an interior of a vehicle, an exterior of a vehicle, and a chamber defined by a headlamp lens and reflector.

The ink 204 can be located close to the exterior of the portion 200 so in situations where heat is required (e.g. defrosting or defogging), heat can diffuse through the overlying film layer 206 and scratch-resistant coating 208. The ink 204 can act as a heat source, so placing it close to a surface to be defrosted or defogged allows it to be in situated in a location that increases in efficacy of the system as compared to systems with the heat source place further from the surface to be defrosted or defogged. Heat also can diffuse through the substrate 202, but the substrate 202 acts as an insulator and is usually much thicker than the film layer 206 and the scratch resistance coating 208. According to one exemplary embodiment, the ink 204 is provided at a distance of between 0.1 mm and 1.0 mm from the outer surface of the portion 200, although such distance may differ in other embodiments.

FIG. 4 is a top plan view of a defrosting system 400 incorporated into a window 401 (e.g., a rear vehicle window). The defrosting system 400 includes a plurality of conductive ink lines 402, a plurality of bus bars 404, and a plurality of electrical connectors 406 integrated into a portion of the system 400. The plurality of conductive ink lines 402 and the plurality of bus bars can form a defroster grid 408. An example design of a defrosting system for plastic component 400 is a layout of spaced horizontal conductive ink lines 402 to form one part of the defroster grid 408. The width of each conductive ink line 402 may be between 0.75 mm and 1.5 mm, but may differ according to other exemplary embodiments. The width of each conductive ink line 402 can be uniform or it can be variable. The distance between each conductive ink line can be 25 mm or another distance suitable for a particular design. The conductive grid lines 402 can span almost the entire length of the window 402 or may span only a portion thereof. The ends of the conductive grid lines 402 can be connected by the bus bars 404.

The bus bars 404 can each be a strip or bar used to connect the conductive grid lines 402 together. The bus bar 404 can be comprised of the same or similar material as the conductive grid lines 402. The bus bar 404 can be a conduit to supply the current to any number of connected conductive grid lines 402. The bus bar 404 and the conductive grid lines 404 can be printed onto the film layer 206 using conductive ink. The plurality of electrical connectors 406 can be located at one end of the bus bar 404 or at any other location connected to the defroster grid 408. The plurality of electrical connectors 406 can be located at opposite ends of the bus bar 404.

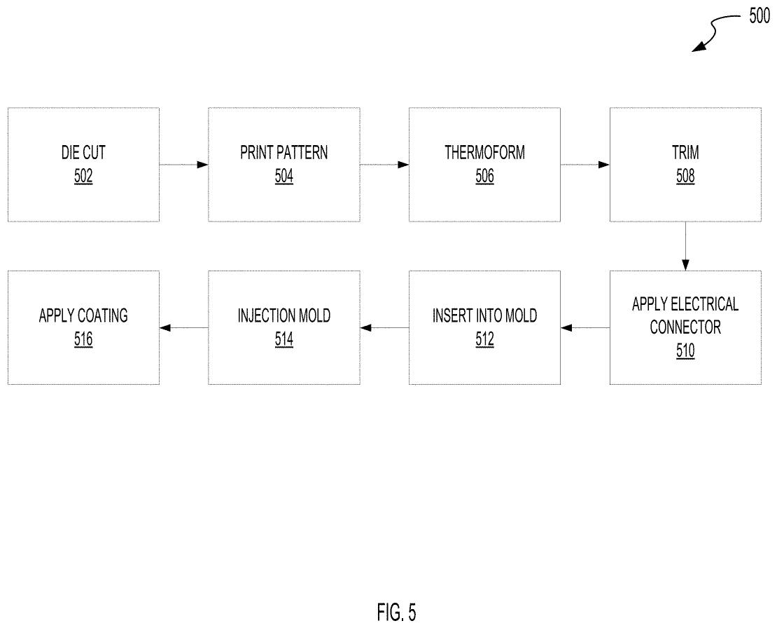

FIG. 5 is a flow chart illustrating an implementation of a method 500 for forming a defrosting system for a plastic component. The method can include a step of die cutting 502 a thin film sheet to form a film layer such as film layer 206. The thin film sheet may be composed of coextruded polycarbonate and PMMA or other suitable materials. Die cutting 502 allows the film sheet to be cut to a manageable size and can prepare it for a processing step in which a conductive layer of ink 204 is applied thereto.

The method can include a step 504 of printing a pattern onto the die cut film sheet. Printing a pattern can be comprised of applying a conductive layer of ink 204 to form the conductive ink lines 402 and bus bars 404. The conductive ink lines 402 and bus bars 404 form the basis of the defroster grid 408. The pattern can be printed in a variety of ways, including screen-printing, pad printing, and inkjet printing. The conductive ink can undergo a curing process to set the ink and improve its microstructure, reduce its sheet resistance, increase conductivity, and improve performance. The curing process can be established at various temperatures for a period of time. The curing process can be brought about in a variety of ways, such as by electron beams, heat, ultraviolet radiation or chemical additives. Using a conductive ink that does not need to set a high curing temperature allows the method to be operated at a lower temperature than conventional methods.

Preforming steps can be included in the process in the scenario where the film layer 206 containing the conductive layer of ink 204 should have a geometry that is different from that which it has when the printing step 504 is completed. The preforming steps can a step 506 of thermoforming the film layer 206 containing the conductive layer of ink 204. Thermoforming is a process wherein the film layer 206 can be heated to a temperature which allows it to be molded and shaped and then formed to a specific shape in a mold. This process step allows the substrate to be formed into a desired shape, such as an irregular geometry (e.g. vehicle taillights) or a curved sheet (e.g. vehicle back windshield).

A step 508 involves trimming the thermoformed sheet that is produced from method step 506. The step of trimming the thermoformed sheet is performed to create a usable product after the thermoforming step. Trimming the thermoformed sheet can allow it to adopt a geometry closer to that of the final desired geometry. Trimming the thermoformed sheet can be achieved in a variety of ways, such as die-cutting or manual trimming.

The method can include a step 510 of applying a plurality of electrical connectors 406 to the bus bar 404. The step of applying a plurality of electrical connectors 406 allows the bus bar 404 and conductive ink lines 402 to be connected to an external circuit. The external circuit can supply the electricity needed to flow through the defroster grid 408 and heat up the defroster grid 408. Heating up the defroster grid 408 can allow heat to flow through a film layer 206 and a scratch-resistant coating 208 to reach the exterior environment. The plurality of electrical connectors 406 can allow for a connection to a vehicle's electrical system for operation of a defroster.

The method can include a step 512 of inserting the die-cut sheet into a mold. The sheet can be received after method step 504 in which the pattern of conductive ink lines 204 is printed 504 onto the film layer 206. The sheet can be received after method step 506 wherein the sheet is thermoformed to achieve a desired geometry. The sheet can be received after method step 508 wherein the sheet is thermoformed and trimmed to achieve a desired geometry. Inserting the sheet into a mold can be performed though an automated process, such as using a robotic arm to place the sheet into a mold, or may be performed manually according to other exemplary embodiments.

The method can include a step 514 of injection molding. The step of injection molding can be performed so that material is deposited on the side of the sheet that is not interfacing with the mold in method step 512. Injection molding can be a manufacturing process for injecting material into a mold. The process of injection molding can be used to deposit the substrate 202 onto the film layer 206 and ink 204.

A coating may then be applied to the structure formed of the substrate, ink, and film layer. The method can include a step 516 of applying a coating to one or both sides of the structure. The coating can be a hard coat and can be used to provide a scratch-resistant coating to the sheet. The coating can be applied onto all sides of the structure to protect it from external abrasions or scratches. Applying a coating 516 can be performed though an automated process, such as using a robotic arm to spray the coating onto the sheet, or may be performed manually according to other exemplary embodiments. It should be noted that the coating may be applied to only one side of the structure (e.g., for a headlight or taillight application where only the externally-facing surface is confronted with objects that may result in scratching of such surface) or on both sides of the structure (e.g., in a vehicle window application where both sides of the structure may be confronted with such objects).

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A defrosting system for a window, headlight, or taillight for a vehicle, the defrosting system comprising:
a polymeric substrate;
an ink layer disposed on the substrate and comprising a conductive or resistive ink; and
a film layer disposed on the ink layer such that the ink layer is between the film layer and the polymeric substrate layer.

2. The defrosting system of claim 1, further comprising a first scratch-resistant coating disposed on the film layer.

3. The defrosting system of claim 2, further comprising a second scratch-resistant coating disposed on the polymeric substrate layer.

4. The defrosting system of claim 1, wherein the ink layer has a grid pattern.

5. The defrosting system of claim 1, further comprising at least one bus bar in contact with the ink layer.

6. The defrosting system of claim 1, wherein the ink layer is embedded into the film layer.

7. The defrosting system of claim 1, wherein the film layer is overmolded over the ink layer to encapsulate the ink layer between the film layer and the substrate.

8. The defrosting system of claim 1, wherein the ink layer is at least one of a defroster, defogger, light sensor, rain sensor, snow sensor, antenna, or touch sensor.

9. The defrosting system of claim 1, wherein a first side of the film layer is in contact with the ink layer and a second side of the film layer is a defrosting surface, and wherein the ink layer is located a distance of between 0.1 mm and 1.0 mm from the defrosting surface.

10. The defrosting system of claim 1, wherein the film layer comprises coextruded polycarbonate and polymethylmethacrylate.

11. The defrosting system of claim 1, wherein the ink layer comprises at least one of a thermally cured ink, a UV-cured ink, or an air-dry ink.

12. The defrosting system of claim 1, wherein the ink layer comprises at least one of silver, copper, or a conductive polymer.

13. A method for forming a defrosting system for a window, headlight, or taillight for a vehicle, the method comprising:
die-cutting a film layer;
printing an ink layer onto the film layer;
applying a bus bar and at least one electrical connector on the film layer, the bus bar and at least one electrical connector in contact with at least a portion of the ink layer;
inserting the film layer into a mold; and
injecting molding a polymeric substrate onto the film layer to encapsulate the ink layer between the film layer and the polymeric substrate;
wherein a first side of the film layer contacts a first side of the ink layer, a first side of the polymeric substrate contacts the first side of the film layer, and the first side of the polymeric substrate contacts a second side of the ink layer.

14. The method of claim 13, further comprising:
thermoforming the film layer; and
trimming the thermoformed film layer.

15. The method of claim 12, further comprising applying a coating onto the film layer.

16. The method of claim 15, further comprising applying the coating to the substrate.

17. The method of claim 12, wherein the ink layer is at least one of a defroster, defogger, light sensor, rain sensor, snow sensor, antenna, or touch sensor.

18. The method of claim 12, wherein the film layer has a thickness in the range of 0.1 mm to 3.0 mm.

19. The method of claim 12, wherein the ink layer is located a distance of between 0.1 mm and 1.0 mm from a defrosting surface.

20. The method of claim 12, wherein the ink layer comprises at least one of a thermally cured ink, UV-cured ink, or air-dry ink.
